(19) United States
(12) Patent Application Publication
(10) Pub. No.: US 2011/0267240 A1
(43) Pub. Date: Nov. 3, 2011

(54) PORTABLE WIRELESS DEVICE

(75) Inventors: Haruhiko Kakitsu, Shizuoka (JP); Toshihiro Asahina, Kanagawa (JP)

(73) Assignee: PANASONIC CORPORATION, Osaka (JP)

(21) Appl. No.: 13/143,583

(22) PCT Filed: Nov. 24, 2009
(86) PCT No.: PCT/JP2009/006320

§ 371 Date: Jul. 7, 2011

(30) Foreign Application Priority Data
Jan. 9, 2009 (JP) 2009-003635

(51) Int. Cl. H01Q 1/24

(52) U.S. Cl. 343/702

(57) ABSTRACT

A portable wireless device wherein antenna performance deterioration when using a slide mechanism having a metal member can be prevented. In this portable wireless device, a second housing (102) is slidably attached to a first housing (101). The circuit board (105) is provided in the first housing (101) and has a slit (110) which extends in a direction crossing the sliding direction of the first housing (101) and is located below a power feed unit (109) when the wireless device is opened. The circuit board (108) is provided in the second housing (102) and overlaps with the bottom side of the circuit board (105) as seen from a plan view when the first housing (101) is slid open. The antenna (107) is provided on the upper side of the second housing (102). The power feed unit (109) supplies power to the antenna (107) at a position close to the antenna (107).

### TECHNICAL FIELD

The present invention relates to a portable radio device. More particularly, the present invention relates to a portable radio device in which multiple casings are connected with each other in a slidable fashion and are placed in an open state and a closed state following slide operations.

### BACKGROUND ART

Conventionally, a portable radio device in which an upper casing and a lower casing are connected in a mutually slidable fashion is known. When this slide portable radio device is placed in an open state, the circuit board of the upper casing and the circuit board of the lower casing partly overlap on top of each other. Also, with a slide portable radio device, each circuit board and a metallic slide component to guide the slide operations of the casings are placed close to each other. Thus, in a conventional slide portable radio device, the circuit board of the upper casing and the circuit board of the lower casing are electromagnetically coupled through a slide component. As a result of this, a conventional slide portable radio device has a problem that, if an antenna is placed in the upper end side of the lower casing and a power feeding section is also located in the upper end side of the lower casing, the current traveling in the circuit board of the upper casing has the opposite phase to the antenna current traveling in the circuit board of the lower casing towards a power feeding section, so that antenna performance is degraded. This kind of problem does not occur in a flip portable radio device in which the circuit board of the upper casing and the circuit board of the lower casing do not overlap one above the other in an open state, and therefore is specific to a slide portable radio device.

To solve the above problem, a method of placing an antenna in the lower end side of the lower casing to allow an antenna current which has the same phase as the current travelling in the circuit board of the upper casing to travel in the circuit board of the lower casing is possible (for example, patent literature 1), or a method of forming a slide mechanism component with an insulating resin is possible.

### CITATION LIST

### Patent Literature

PTL 1
Japanese Patent Application Laid-Open No. 2006-217572

### SUMMARY OF INVENTION

### Technical Problem

However, there is a problem that if an antenna is provided in the lower end side of the lower casing, generally, the lower end side of the lower casing is a part held by a human hand, for example, during a call, so that a human hand becomes a dielectric and degrades antenna performance. Also, there is a problem that, if a slide mechanism component is formed with a resin, compared to the case of forming a slide mechanism component with metal, the mechanical strength becomes low and provides a factor of failure.

It is therefore an object of the present invention to provide a portable radio device that can prevent antenna performance degradation when a slide mechanism using a metal member is provided.

### Solution to Problem

The portable radio device according to the present invention employs a configuration having: a first casing; a second casing that is slidably attached to the first casing; a first circuit board that is provided in the first casing; a second circuit board that is provided in the second casing and that overlaps with a lower side of the first circuit board in a plan view when the first casing slides into an open state; an antenna that is provided in an upper side of the second casing; and a power feeding section that is provided near the antenna and that feeds power to the antenna, and, in this portable radio device, the first circuit board has an insulation section that extends in a direction to cross a slide direction of the first casing and that is located lower than the power feeding section in the open state.

The portable radio device of the present invention employs a configuration having: a first casing; a second casing that is slidably attached to the first casing; a metal section that is flat and that is provide in the first casing; a circuit board that is provided in the second casing and that overlaps with a lower side of the metal section in a plan view when the first casing slides into an open state; an antenna that is provided in an upper side of the second casing; and a power feeding section that is provided near the antenna and that feeds power to the antenna, and, in this portable radio device, the metal section has an insulation section that extends in a direction to cross a slide direction of the first casing and that is located lower than the power feeding section in the open state.

The portable radio device according to the present invention employs a configuration having: a first casing; a second casing that is slidably attached to the first casing; a first circuit board that is provided in the first casing; a second circuit board that is provided in the first casing; a signal wire that connects the first circuit board and the second circuit board; a third circuit board that is provided in the second casing and that overlaps with the second circuit board in a plan view when the first casing slides into an open state; an antenna that is provided in an upper side of the second casing; and a power feeding section that is provided near the antenna and that feeds power to the antenna, and, in this portable radio device, the first circuit board, the second circuit board, and the signal wire form a slit; and the slit has a lengthwise direction that crosses a slide direction of the first casing, and is located lower than the power feeding section in the open state.

### Advantageous Effects of Invention

The present invention can prevent antenna performance degradation when a slide mechanism using a metal member is provided.

### BRIEF DESCRIPTION OF THE DRAWINGS

FIG. 1 is a side view of a portable radio device according to embodiment 1 of the present invention in an open state;

FIG. 2 is a side view of a portable radio device according to embodiment 1 of the present invention in a closed state;

FIG. 3 is a plan view of the first casing according to embodiment 1 of the present invention;

FIG. 4 is a plan view of the circuit board according to embodiment 2 of the present invention;

FIG. 5 is a side view of a portable radio device according to embodiment 3 of the present invention in an open state;

FIG. 6 is a side view of a portable radio device according to embodiment 4 of the present invention in an open state;

FIG. 7 is a plan view of the first casing according to embodiment 5 of the present invention;

FIG. 8 is a plan view of the first casing showing another example of the circuit board according to embodiment 5 of the present invention;

FIG. 9 is a plan view of the first casing showing yet another example of the circuit board according to embodiment 5 of the present invention;

FIG. 10 is a plan view of the first casing showing yet another example of the circuit board according to embodiment 5 of the present invention;

FIG. 11 is a plan view of the first casing according to embodiment 6 of the present invention;

FIG. 12 is a plan view of the first casing showing another example of the first casing according to embodiment 6 of the present invention;

FIG. 13 is a plan view of the first casing according to embodiment 7 of the present invention;

FIG. 14 is a plan view of the first casing showing another example of the first casing according to embodiment 7 of the present invention;

FIG. 15 is a plan view of the first casing according to embodiment 8 of the present invention;

FIG. 16 is a plan view of the first casing showing another example of the first casing according to embodiment 8 of the present invention;

FIG. 17 is a side view of a portable radio device according to embodiment 9 of the present invention in an open state;

FIG. 18 is a plan view of a metal section according to embodiment 9 of the present invention;

FIG. 19 is a plan view of a metal section showing another example of a metal section according to embodiment 9 of the present invention;

FIG. 20 is a plan view of a metal section showing yet another example of a metal section according to embodiment 9 of the present invention;

FIG. 21 is a plan view of the first casing showing another example of the circuit board; and

FIG. 22 is a plan view of the first casing showing another example of a slit provided in the circuit board.

### DESCRIPTION OF EMBODIMENTS

Now, embodiments of the present invention will be explained in detail with reference to the accompanying drawings.

### Embodiment 1

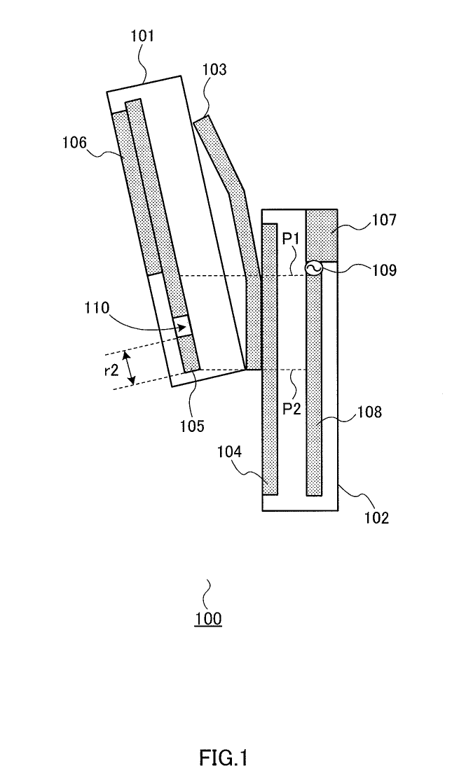

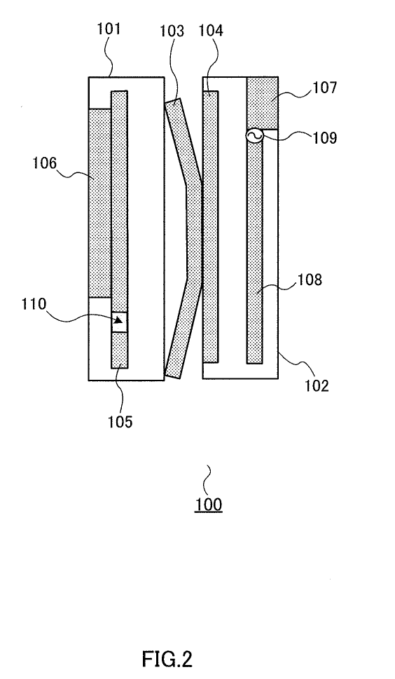

FIG. 1 is a side view of portable radio device 100 according to the embodiment 1 of the present invention in an open state. FIG. 2 is a side view of portable radio device 100 according to the embodiment 1 of the present invention in a closed state.

Portable radio device 100 is mainly formed with first casing 101, second casing 102, first slide mechanism section 103, second slide mechanism section 104, circuit board 105, display section 106, antenna 107, circuit board 108, and power feeding section 109.

First casing 101 is formed in a rectangular shape in a plan view and is slidably attached to second casing 102 to switch from the open state of FIG. 1 to the closed state of FIG. 2 or to switch from the closed state of FIG. 2 to the open state of FIG. 1, by sliding with first slide mechanism section 103. Thus, first casing 101 is attached to second casing 102 to be able to slide along the lengthwise direction of first casing 101 (a vertical direction in FIG. 1 and FIG. 2). In the open state of FIG. 1, by sliding with first slide mechanism section 103 that is bent to erect, first casing 101 is held on second casing 102 in an erect state. First casing 101 has circuit board 105 and display section 106.

Second casing 102 is formed in a rectangular shape in a plan view and is slidably attached to first casing 101 to switch from the open state of FIG. 1 to the closed state of FIG. 2 or to switch from the closed state of FIG. 2 to the open state of FIG. 1, by sliding with first slide mechanism section 104. Also, second casing 102 has second slide mechanism section 104 and circuit board 108. Second casing 102 has antenna 107 in the upper end part (the upper end part of FIG. 1 and FIG. 2). In an open state, second casing 102 holds first casing 101 in an erect state as shown in FIG. 1, and overlaps with first casing 101 in a closed state as shown in FIG. 2.

First slide mechanism section 103 is formed by bending a metal plate. Also, first slide mechanism section 103 slides in a vertical direction in FIG. 1 and FIG. 2, guided by a rail (not shown) provided in second slide mechanism section 104. First slide mechanism section 103 is attached to first casing 101 and slides with first casing 101. By sliding along a bent and erect shape guided by second slide mechanism section 104, in an open state, first slide mechanism section 103 holds first casing 101 in an erect state with respect to second casing 102.

Second slide mechanism section 104 is made from a metal plate, is attached to second casing 102, and slides with second casing 102. Second slide mechanism section 104 has a rail (not shown) to guide the slide operations of first slide mechanism section 103.

Circuit board 105 is provided in first casing 101 and display section 106 such as LCD is attached. Circuit board 105 has slit 110 extending from one end in a perpendicular direction to a slide direction (a horizontal direction in FIG. 1 and FIG. 2) of first casing 101 and penetrating circuit board 105 in a thickness direction. When first casing 101 and second casing 102 are in an open state, slit 110 is located lower (lower than broken line P1 in FIG. 1) than antenna 107 and power feeding section 109. Here, slit 110 is provided to suppress the current to travel below slit 110 in circuit board 105 in FIG. 1. Thus, a “slit” is not mandatory, and, as long as an insulation section is provided, it is possible to achieve the effect of the present embodiment. With the present embodiment, a case will be described where slit 110 is provided as one example of an insulation section. The details of slit 110 will be described later.

Display section 106 is, for example, a liquid crystal display apparatus (LCD) and is attached to circuit board 105. Display section 106 shows, for example, image data that portable radio device 100 receives.

By being attached above circuit board 108, antenna 107 is provided in an upper part of second casing 102. By this means, when the lower side of second casing 102 is held by a human hand, antenna performance degradation caused by the hand can be prevented. Antenna 107 is fed power from power feeding section 109.

Circuit board 108 is provided in second casing 102, and antenna 107 and power feeding section 109 are provided in its upper end part. In the open state of FIG. 1, on a plan view, the upper side of circuit board 108 overlaps, with the lower side of circuit board 105 (part between broken line P1 and broken line P2 in FIG. 1).

Power feeding section 109 is provided above circuit board 108 and feeds power to antenna 107. Power feeding section 109 does not have to be provided in circuit board 108 and can be provided in an arbitrary location around antenna 107.

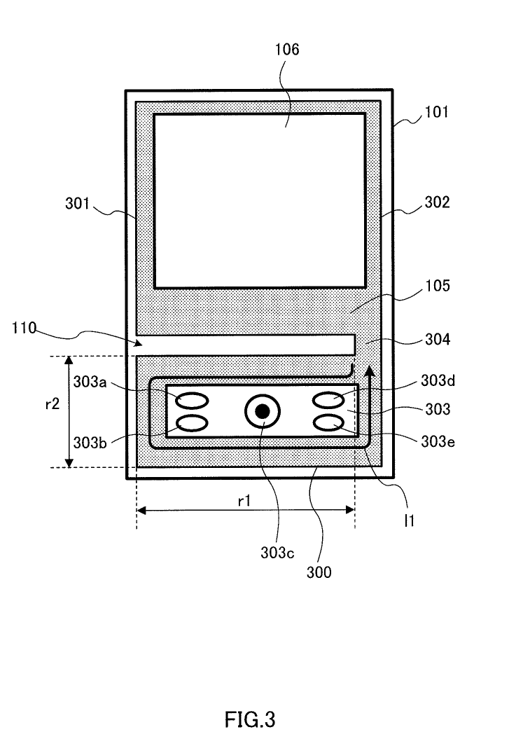

Next, slit 110 provided in circuit board 105 will be described using FIG. 3. FIG. 3 is a plan view of first casing 101.

On a plan view, circuit board 105 is provided almost over the entire surface of first casing 101. In circuit board 105, slit 110 is formed from one end part 301 of circuit board 105 in a perpendicular direction to a slide direction (a vertical direction in FIG. 3) of first casing 101. Also, in circuit board 105, over slit 110, display section 106 is provided in an upper part (an upper part in FIG. 3), and operation key section 303 is provided in a lower part (a lower part in FIG. 3). In narrow section 304 of circuit board 105, circuit patterns (not shown) are formed to transmit the signals input from operation key section 303, to a signal processing section such as a CPU (not shown) mounted on circuit board 105.

Slit 110 is a through hole that is formed in circuit board 105 and that penetrates circuit board 105 in a thickness direction (a perpendicular direction to the sheet of FIG. 3). The length of width r1 (see FIG. 3) from end part 301 of slit 110 is determined such that the perimeter of the lower side of slit 110 in circuit board 105 is half-wavelength (λ/2) of the frequency used by portable radio device 100. The higher the frequency used by portable radio device 100, the smaller the perimeter below slit 110 in circuit board 105 is placed. Here, the perimeter below slit 110 in circuit board 105 is referred to the length (11 in FIG. 3) along slit 110, end parts 301, 300, and 302 of circuit board 105, in area r2 below slit 110 in circuit board 105.

Operation key section 303 has contact point patterns 303a-303e. Operation key section 303 has contact point patterns 303a-303e to be electrically connected when multiple operation keys (not shown) provided in first casing 101 are pressed.

Contact point patterns 303a-303e electrically connect with the conductive movable contact points provided in the operation keys when the operation keys (not shown) provided in first casing 101 are pressed. Contact point patterns 303a-303e electrically connect with circuit patterns (not shown) connected to a signal processing section (not shown) provided on circuit board 105. By this means, for example, when one operation key is pressed, multiple contact point patterns 303a-303e are connected with the movable contact point provided in the pressed operation key, are placed in an electrically conducting state (ON) with respect to each other, and therefore transmit an ON signal to a signal processing section through the circuit patterns. On the other hand, when the press of one operation key is released, multiple contact point patterns 303a-303e are disconnected from the movable contact point provided in the operation key where the press is released, are placed in an electrically non-conducting state (OFF) with respect to each other, and therefore transmit an OFF signal to a signal processing section through the circuit patterns.

In fact, generally, the signals output from each contact point patterns 303a-303e of operation key section 303 are two kinds of signals, ON and OFF, so that the circuit configuration in operation key section 303 is simpler than a circuit configuration, for example, in IC having multiple input-output terminals.

Next, the reason antenna performance of antenna 107 is not degraded in portable radio device 100 having the above configuration will be explained.

As conventionally known, in the open state of FIG. 1, circuit board 105 and circuit board 108 are electrically connected at the part (part between P1 and P2) where circuit board 105 and circuit board 108 overlap one above the other, through first slide mechanism section 103 and second slide mechanism section 104. However, the present embodiment provides slit 110to electrically disconnect area r2 below slit 110 in circuit board 105, and suppresses the current transmitting in area r2 below slit 110 in circuit board 105. Thus, although conventionally in area r2, the current transmits in the direction to cancel antenna current transmitting on circuit board 108 upward in FIG. 1 towards power feeding section 109 in antenna 107, the present embodiment provides slit 100 to suppress the current transmitting in area r2. By this means, the present embodiment can prevent antenna performance degradation of antenna 107.

Therefore, the present embodiment provides, in a circuit board provided in the first casing, a slit that is located lower than a power feeding section in an open state, so that it is possible to electrically disconnect the part of the circuit board below the slit, and to prevent antenna performance degradation when a slide mechanism using a metal member is provided. The present embodiment provides an operation key section having a simple configuration below the slit provided in the circuit board, so that it is possible to provide the circuit patterns in a narrow area that is created by providing the slit. With the circuit board provided in the first casing, the present embodiment suppresses the current transmitting in the area below the slit and also provides an operation key section in the area below the slit, so that it is possible to reduce the influence to the antenna current caused by a hand operating the operation key section.

Although with the present embodiment a slit is formed from one end part of a circuit board, the present embodiment is not limited to this, and it is equally possible to form a slit that extends from any arbitrary location in the circuit board.

### Embodiment 2

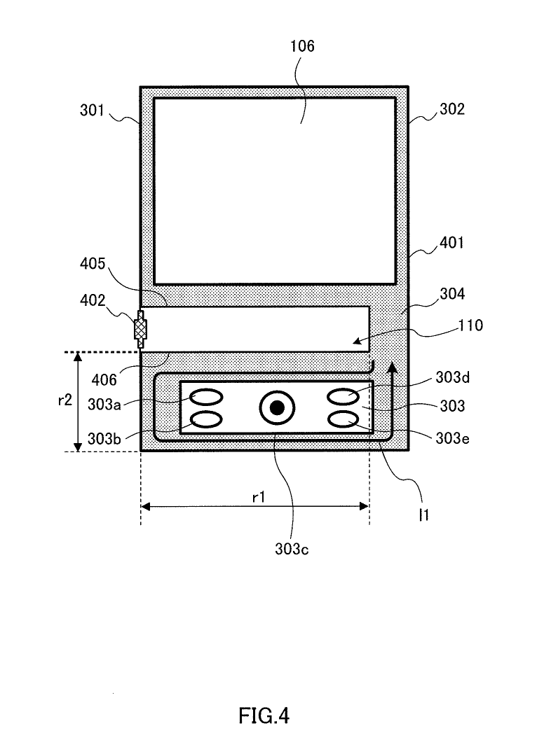

FIG. 4 is a plan view showing circuit board 401 according to embodiment 2 of the present invention.

Compared to circuit board 105 according to embodiment 1 shown in FIG. 3, circuit board 401 shown in FIG. 4 adds reactance element 402. Also, parts in FIG. 4 that are the same as in FIG. 3 will be assigned the same reference numerals as in FIG. 3 and overlapping descriptions will be omitted. Also, the portable radio device of the present embodiment has the same configuration as the above embodiment 1 except that circuit board 401 is provided instead of circuit board 105, so that the overlapping descriptions will be omitted. Also, FIG. 4 will be described using the reference numerals of FIG. 1 except for circuit board 401.

On a plan view, circuit board 401 is provided almost over the entire surface of first casing 101 in a plan view. In circuit board 401, slit 110 is formed from one end part 301 of circuit board 105 in a perpendicular direction to a slide direction (a vertical direction in FIG. 4) of first casing 101. Also, in circuit board 401, over slit 110, display section 106 is provided in an upper part (an upper part in FIG. 4), and operation key section 303 is provided in a lower part (a lower part in FIG. 4). In narrow section 304 of circuit board 401, circuit patterns (not shown) are formed to transmit the signals input from operation key section 303, to a signal processing section such as a CPU (not shown) mounted on circuit board 105. In circuit board 401, reactance element 402 that connects end part 405 and end part 406 forming slit 110 and opposing each other is provided.

Reactance element 402 electrically connects between end part 405 and end part 406 forming slit 110 in circuit board 401 and opposing each other, and adjusts the electrical length of an antenna. Specifically, reactance element 402 electrically connects the ground part of end part 405 and the ground part of end part 406, and consequently adjusts the electrical length of antenna 107 in circuit board 401.

Therefore, besides the above effect of embodiment 1, the present embodiment electrically connects between end parts forming a slit in a circuit board and opposing each other, by means of a reactance element, and consequently can achieve optimal antenna performance in the desired frequency. Especially, if the portable radio device is multiband-compatible, a reactance element adjusts the electrical length, and consequently the portable radio device can achieve optimal antenna performance in each band.

Although with the present embodiment a slit is formed from one end part of a circuit board, the present embodiment is not limited to this, and it is equally possible to form a slit that extends from any arbitrary location in the circuit board.

### Embodiment 3

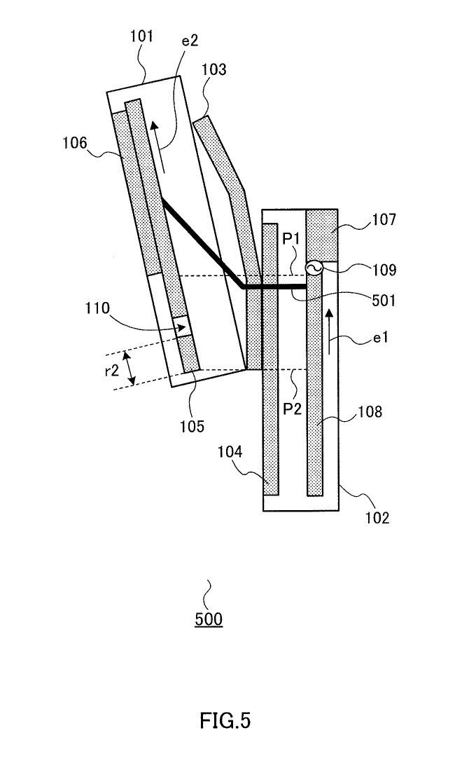

FIG. 5 is a side view of portable radio device 500 according to the embodiment 3 of the present invention in an open state.

Compared to portable radio device 100 according to embodiment 1 shown in FIG. 1, portable radio device 500 shown in FIG. 5 adds cable 501. Also, parts in FIG. 5 that are the same as in FIG. 1 will be assigned the same reference numerals as in FIG. 1 and overlapping descriptions will be omitted.

Portable radio device 500 is mainly formed by first casing 101, second casing 102, first slide mechanism section 103, second slide mechanism section 104, circuit board 105, display section 106, antenna 107, circuit board 108, power feeding section 109, and cable 501.

Circuit board 105 is provided in first casing 101 and display section 106 such as LCD is attached. Circuit board 105 has slit 110 extending from one end in a perpendicular direction to a slide direction (a vertical direction in FIG. 5) of first casing 101 and penetrates circuit board 105 in a thickness direction. When first casing 101 and second casing 102 are in an open state, slit 110 is located lower (lower than broken line P1 in FIG. 5) than antenna 107 and power feeding section 109. Above slit 110, the ground part of circuit board 105 is electrically connected with the ground part of circuit board 108 by means of cable 501. A “slit” is not mandatory, and, as the above embodiment 1, as long as an insulation section is provided, it is possible to gain the effect of the present embodiment.

Circuit board 108 is provided in second casing 102, and antenna 107 and power feeding section 109 are provided in its upper end part. The ground part of circuit board 108 is electrically connected with the ground part of circuit board 105 by means of cable 501.

Cable 501 is, for example, a flexible cable (FPC), and transmits a signal received and processed in a radio circuit (not shown) provided in circuit board 108 to, for example, display section 106 provided in circuit board 105. Also, cable 501 electrically connects the ground part of circuit board 105 and the ground part of circuit board 108. In this case, cable 501 connects with the ground part of circuit board 105 above slit 110.

Next, the flow of antenna current in portable radio device 500 will be described.

In the ground part of circuit board 108 in portable radio device 500, antenna current e1 transmits toward power feeding section 109, that is, upward in FIG. 5. The ground part of circuit board 105 and the ground part of circuit board 108 are electrically connected by cable 501, and therefore antenna current e2 transmits upward in FIG. 5 in the ground part of circuit board 105. Thus, antenna current e2 transmitting in circuit board 105 transmits in the same direction as antenna current e1 transmitting in circuit board 108, and consequently can be regarded as an extension of antenna current e1 transmitting in circuit board 108. On the other hand, the ground part of circuit board 105 provides slit 110 to suppress the current transmitting downward in FIG. 5. By this means, antenna 107, circuit board 105, circuit board 108, and power feeding section 109 can form an antenna.

In fact, conventionally, in circuit board 105, the current transmits in the direction to cancel antenna current e1 of circuit board 108, so that, if cable 501 connects the ground part of circuit board 105 and the ground part of circuit board 108, the current transmitting in the direction to cancel antenna current e1 is increased. Thus, conventionally, it has been difficult to use the ground part of circuit board 105 as an antenna. On the other hand, circuit board 105 of the present embodiment provides slit 110 to suppress the current transmitting in the direction to cancel the antenna current transmitting in circuit board 108, so that it is possible to actively use the ground part of circuit board 105 as an antenna.

Therefore, besides the above effect of embodiment 1, the present embodiment uses the ground part of the circuit board, which is provided in the first casing located above the second casing, in an open state, as an antenna, so that it is possible to radiate a wave from the circuit board provided in the first casing. By this means, it is possible to expand the distance from the hand holding the second casing to the circuit board radiating a wave, and therefore to achieve good antenna performance. The present embodiment can use a cable used to transmit a signal from the circuit board provided in the second casing to the circuit board provided in the first casing, as a cable to transmit the antenna current on the circuit board provided in the first casing. By this means, there is no need to newly provide a special cable to transmit antenna current on the circuit board provided in the first casing, so that it is possible to gain good antenna performance without increasing the manufacturing cost.

Although with the present embodiment a reactance element is not provided in slit 110, the present embodiment is not limited to this, and, as shown in FIG. 4, it is possible to provide a reactance element between end parts forming slit 110 in a circuit board. Although with the present embodiment a slit is formed from one end part of the circuit board, the present embodiment is not limited to this, and it is equally possible to form a slit that extends from any arbitrary location in the circuit board.

### Embodiment 4

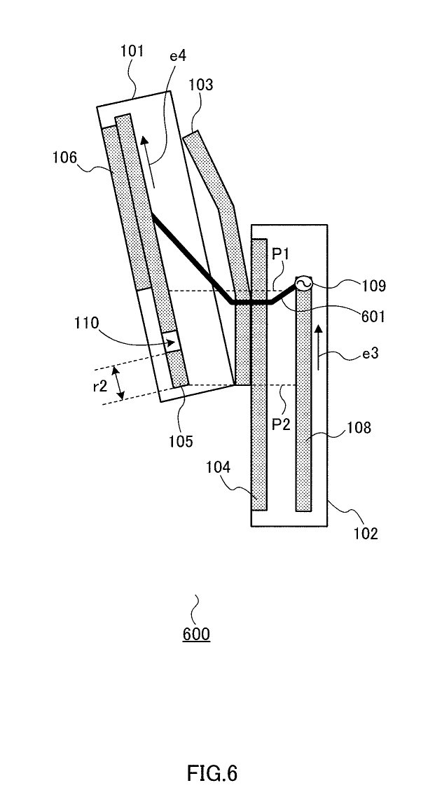

FIG. 6 is a side view of portable radio device 600 according to the embodiment 4 of the present invention in an open state.

Compared to potable radio device 100 according to embodiment 1 shown in FIG. 1, portable radio device 600 shown in FIG. 6 removes antenna 107 and adds power feeding line 601. Also, parts in FIG. 6 that are the same as in FIG. 1 will be assigned the same reference numerals as in FIG. 1 and overlapping descriptions will be omitted.

Portable radio device 600 is mainly formed with first casing 101, second casing 102, first slide mechanism section 103, second slide mechanism section 104, circuit board 105, display section 106, circuit board 108, power feeding section 109, and power feeding line 601.

Power feeding section 109 is provided above circuit board 108. Power feeding section 109 feeds power to the ground part of circuit board 105 through power feeding line 601.

Power feeding line 601 electrically connects power feeding section 109 and circuit board 105, and feeds power to the ground part of circuit board 105. In this case, power feeding line 601 feeds power to the ground part of circuit board 105 above slit 110.

Circuit board 105 is provided in first casing 101 and display section 106 such as LCD is attached. Circuit board 105 has slit 110 extending from one end in a perpendicular direction to a slide direction (a vertical direction in FIG. 6) of first casing 101 and penetrates circuit board 105 in a thickness direction. When first casing 101 and second casing 102 are in an open state, slit 110 is located lower (lower than broken line P1 in FIG. 6) than power feeding section 109. Above slit 110, the ground part of circuit board 105 is fed power from power feeding section 109 through power feeding line 601. A “slit” is not mandatory and, as the embodiment 1, as long as an insulation section is provided, it is possible to achieve the effect of the present embodiment.

Next, the flow of antenna current in portable radio device 600 will be described.

In the ground part of circuit board 108 in portable radio device 600, antenna current e3 transmits towards power feeding section 109, that is, upward in FIG. 6 The ground part of circuit board 105 is fed power from power feeding section 109 through power feeding line 601, so that antenna current e4 transmits from the connecting part of circuit board 105 and power feeding line 601 upward in FIG. 6. Thus, antenna current e4 transmitting in circuit board 105 transmits in the same direction as antenna current e3 transmitting in circuit board 108. On the other hand, the ground part of circuit board 105 provides slit 110 and therefore suppresses the current transmitting downward in FIG. 6. By this means, circuit board 105, circuit board 108, and power feeding section 109 can form a dipole antenna.

In fact, conventionally, in circuit board 105, current transmits in the direction to cancel antenna current e3 of circuit board 108, so that, if power feeding section 109 feeds power to the ground part of circuit board 105, the current transmitting in the direction to cancel antenna current e3 is increased. Thus, conventionally, it has been impossible to form a dipole antenna. On the other hand, circuit board 105 of the present embodiment suppresses the current transmitting in the direction to cancel the antenna current transmitting in circuit board 108, so that it is possible to actively use the ground part of circuit board 105 as an antenna and to form a dipole antenna.

Besides the above effect of embodiment 1, by feeding power to the ground part of the circuit board provided in the first casing, the present embodiment can form a dipole antenna.

Although with the present embodiment a reactance element is not formed in slit 110, the present embodiment is not limited to this, and as shown in FIG. 4 it is possible to provide a reactance element between end parts forming slit 110 in a circuit board. Although with the present embodiment a slit is formed from one end part of a circuit board, the present embodiment is not limited to this, and it is equally possible to form a slit that extends from any arbitrary location in the circuit board.

### Embodiment 5

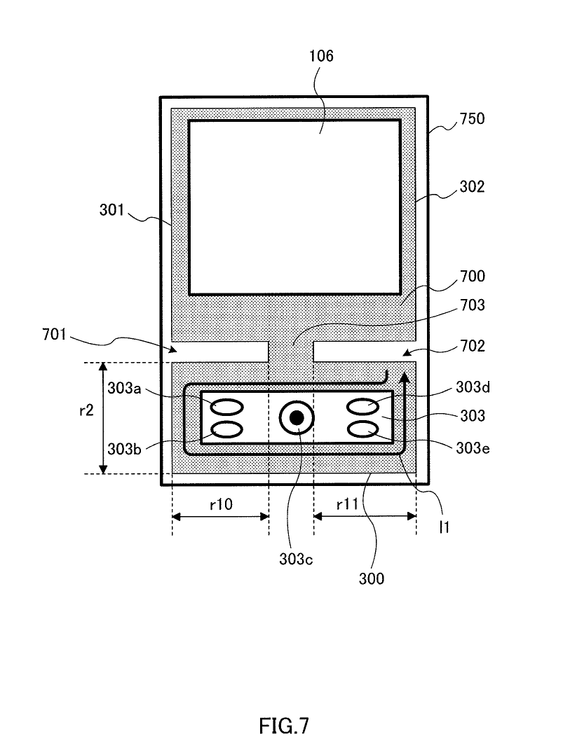

FIG. 7 is a plan view of first casing 750 according to embodiment 5 of the present invention.

Compared to first casing 101 according to embodiment 1 shown in FIG. 3, first casing 750 shown in FIG. 7 has circuit board 700 instead of circuit board 105. Compared to circuit board 105 according to embodiment 1 shown in FIG. 3, circuit board 750 shown in FIG. 7 has slit 701 and slit 702 instead of slit 110 and has narrow section 703 instead of narrow section 304. Also, parts in FIG. 7 that are the same as in FIG. 3 will be assigned the same reference numerals as in FIG. 3 and overlapping descriptions will be omitted. The portable radio device except first casing 750 according to the present embodiment is the same as the above embodiment land the descriptions will be omitted.

First casing 750 is formed in a rectangular shape in a plan view and is slidably attached to second casing 102 to switch from an open state to a closed state or to switch from a closed state to an open state, by sliding with first slide mechanism section 103. Thus, first casing 750 is attached to second casing 102 to be able to slide in the lengthwise direction of first casing 750. In an open state, first casing 750 slides with first slide member 103 that is bent to erect, and therefore is held on second casing 102 in an erect state. First casing 750 has circuit board 700 and display section 106.

Circuit board 700 is provided in first casing 750 and display section 106 such as LCD is attached. Circuit board 700 has slit 701 and slit 702 extend from an end part in a perpendicular direction to a slide direction of first casing 750 and penetrate circuit board 700 in a thickness direction. When first casing 750 and second casing 102 are in an open state, slit 701 and slit 702 are located lower than antenna 107 and power feeding section 109. Here, slit 701 and slit 702 are provided to suppress the current to travel in the lower part than slit 701 and slit 702 in circuit board 700. Thus, a “slit” is not mandatory, and, as long as an insulation section is provided, it is possible to achieve the effect of the present embodiment. In the present embodiment, a case will be described where slit 701 and slit 702 are provided as one example of an insulation section.

Specifically, on a plan view, circuit board 700 is provided almost over the entire surface of first casing 750. In circuit board 700, slit 701 is formed from one end part 301, which is in the lateral direction (a horizontal direction in FIG. 7) of circuit board 700, in a perpendicular direction to a slide direction (a vertical direction in FIG. 7) of first casing 101. In circuit board 700, slit 702 is formed from one end part 302, which opposes to end part 301 in the lateral direction of circuit board 700, in a perpendicular direction to a slide direction of first casing 750. By providing slit 701 and slit 702, circuit board 700 forms narrow section 703. Circuit board 700 defines slit 701 and slit 702 as a boundary, provides display section 106 in the upper part (the upper part in FIG. 7), and provides operation key section 303 in the lower part (the lower part in FIG. 3). In narrow section 703 of circuit board 700, circuit patterns (not shown) are formed to transmit the signals input from operation key section 303, to a signal processing section such as a CPU (not shown) mounted on circuit board 700.

Slit 701 is a through hole that is formed in circuit board 700 and that penetrates circuit board 700 in a thickness direction (a perpendicular direction to the sheet of FIG. 7). It is possible to change the total length (see FIG. 7) of width r10 from end part 301 of slit 701 and width r11 from end part 302 of slit 702, according to the frequency used by the portable radio device.

As conventionally known, the portable radio device having the above configuration electrically connects circuit board 750 and circuit board 108, in an open state, at the point where circuit board 700 and circuit board 108 overlap one above the other. However, the present embodiment provides slit 701 and slit 702 to electrically disconnect area r2 in circuit board 700 below slit 701 and slit 702, and therefore suppresses the current transmitting in area r2 in circuit board 700 below slit 701 and slit 702. Thus, although conventionally in area r2, the current has transmitted in a direction to cancel the antenna current transmitting upward on circuit board 108 towards power feeding section 109 of antenna 107, the present embodiment provides slit 701 and slit 702 to suppress the current transmitting in area r2. By this means, the present embodiment can prevent antenna performance degradation of antenna 107.

Therefore, the present embodiment provides, in a circuit board provided in the first casing, a slit that is located lower than a power feeding section in an open state, so that it is possible to electrically disconnect the part of the circuit board below the slit, and to prevent antenna performance degradation when a slide mechanism using a metal member is provided. The present embodiment provides an operation key section having a simple configuration below the slit provided in the circuit board, so that it is possible to provide the circuit patterns in a narrow area that is created by providing the slit. With the circuit board provided in the first casing, the present embodiment suppresses the current transmitting in the area below the slit and also provides an operation key section in the area below the slit, so that it is possible to reduce the influence to the antenna current caused by a hand operating the operation key section.

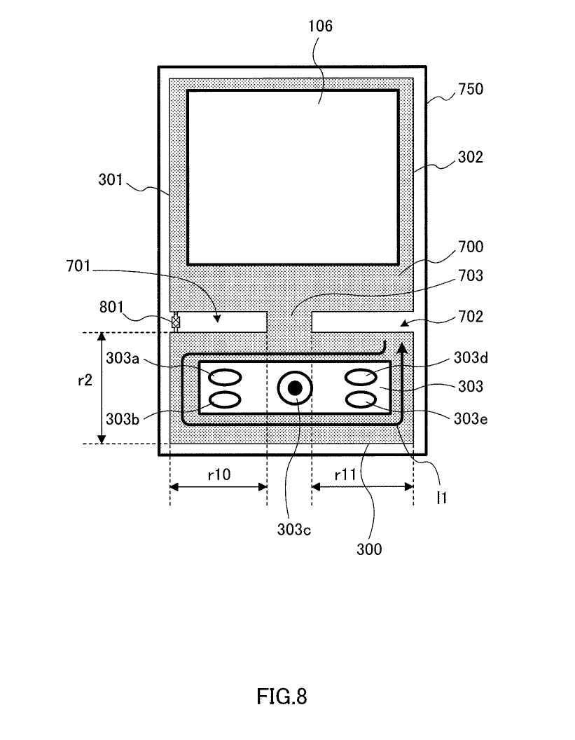

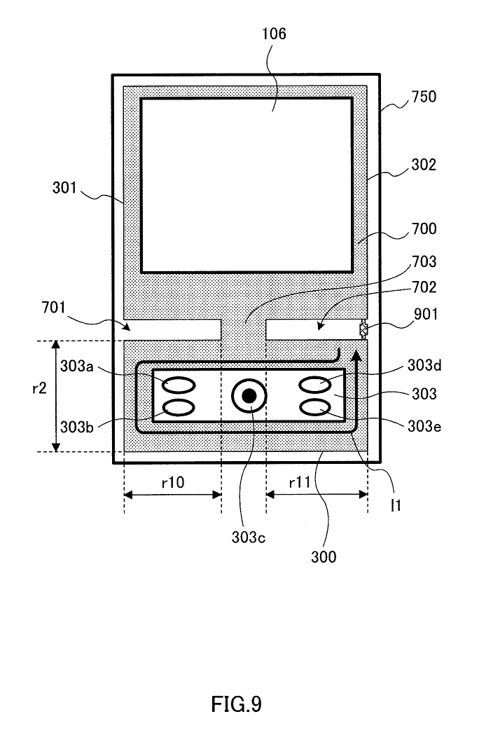

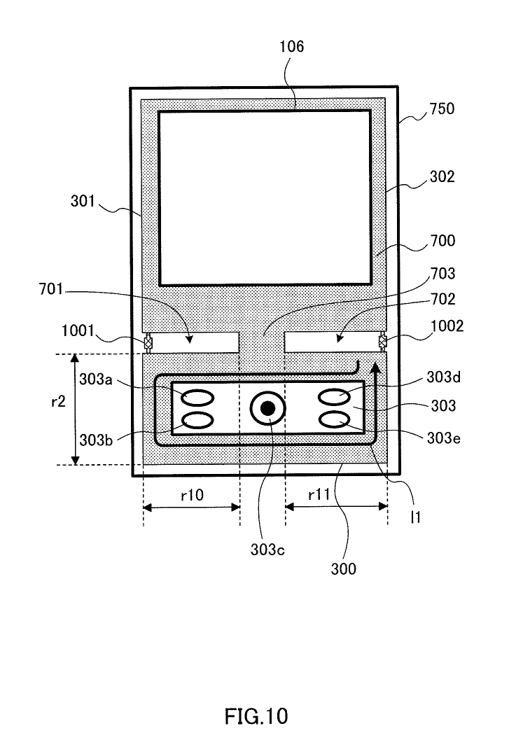

The present embodiment may provide a reactance element in slit 701 and slit 702. FIG. 8 is a plan view of first casing 750 showing another example of the circuit board according to the present embodiment. From FIG. 8, the present embodiment may provide reactance element 801 to electrically connect between end parts forming slit 701 of circuit board 700. FIG. 9 is a plan view of first casing 750 showing yet another example of the circuit board according to the present embodiment. From FIG. 9, the present embodiment may provide reactance element 901 to electrically connect between end parts forming slit 702 of circuit board 700. FIG. 10 is a plan view of first casing 750 showing yet another example of the circuit board according to the present embodiment. From FIG. 10, the present embodiment may provide reactance element 1001 to electrically connect between end parts forming slit 701 of circuit board 700 and reactance element 1002 to electrically connect between end parts forming slit 702 of circuit board 700.

Although the present embodiment extends and forms the slit from an end part of the circuit board, the present embodiment is not limited to this, and it is possible to extend and form the slit from an arbitrary location of the circuit board.

### Embodiment 6

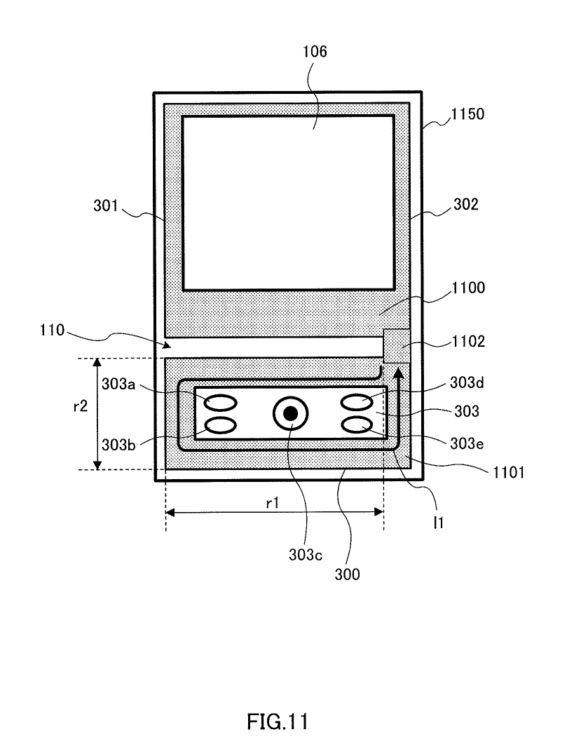

FIG. 11 is a plan view of first casing 1150 according to embodiment 6 of the present invention.

Compared to first casing 101 according to embodiment 1 shown in FIG. 3, first casing 1150 shown in FIG. 11 adds connection line 1102 and has circuit board 1100 and circuit board 1101 instead of circuit board 105. Also, parts in FIG. 11 that are the same as in FIG. 3 will be assigned the same reference numerals as in FIG. 3 and overlapping descriptions will be omitted. The portable radio device except first casing 1150 according to the present embodiment is the same as the above embodiment 1 and the descriptions will be omitted.

First casing 1150 is formed in a rectangular shape in a plan view and is slidably attached to second casing 102 by sliding with first slide mechanism section 103, to switch from an open state to a closed state or to switch from a closed state to an open state. Thus, first casing 1150 is attached to second casing 102 to be able to slide in the lengthwise direction of first casing 1150. In an open state, first casing 1150 slides with first slide member 103 that is bent to erect, and is held on second casing 102 in an erect state. First casing 1150 has circuit board 1100, circuit board 1101, connection line 1102, and display section 106.

Circuit board 1100 is provided in first casing 1150 and display section 106 such as LCD is attached. Circuit board 1100 is electrically connected with circuit board 1101 by connection line 1102.

Circuit board 1101 is provided in first casing 1150 and, in an open state, is located lower than antenna 107 and power feeding section 109.

Connection line 1102 is, for example, a flexible cable (FPC) and electrically connects end part of circuit board 1100 and end part of circuit board 1101. Connection line 1102 transmits the signals input from operation key section 303 to a signal processing section such as a CPU (not shown) mounted on circuit board 1100.

Circuit board 1100, circuit board 1101, and connection line 1102 form slit 110.

In an open state, the portable radio device having the above configuration, electrically connects circuit board 1101 and circuit board 108 through first slide mechanism section 103 and second slide mechanism section 104. However, the present embodiment provides slit 110 to electrically disconnect circuit board 1101 below slit 110, and therefore suppresses the current transmitting in circuit board 1101. Thus, although conventionally in area r2, the current has transmitted in a direction to cancel the antenna current transmitting upward on circuit board 108 towards power feeding section 109 of antenna 107, the present embodiment provides slit 110 to suppress the current transmitting in circuit board 1101. By this means, the present embodiment can prevent antenna performance degradation of antenna 107.

Therefore, the present embodiment provides, in a circuit board provided in the first casing, a slit that is located lower than a power feeding section in an open state, so that it is possible to electrically disconnect the part of the circuit board below the slit, and to prevent antenna performance degradation when a slide mechanism using a metal member is provided. The present embodiment provides an operation key section having a simple configuration below the slit provided in the circuit board, so that it is possible to provide the circuit patterns in a narrow area that is created by providing the slit. With the circuit board provided in the first casing, the present embodiment suppresses the current transmitting in the area below the slit and also provides an operation key section in the area below the slit, so that it is possible to reduce the influence to the antenna current caused by a hand operating the operation key section.

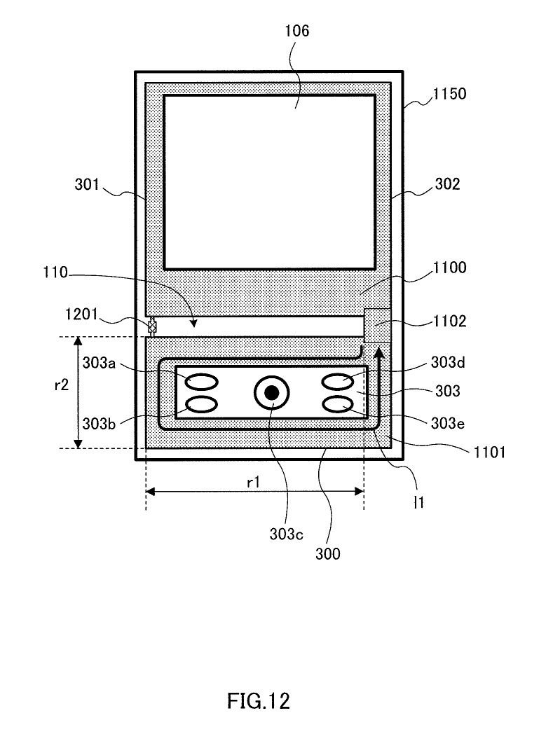

The present embodiment may provide a reactance element in slit 110. FIG. 12 is a plan view of first casing 1150 showing another example of the circuit board according to the present embodiment. From FIG. 12, the present embodiment may provide reactance element 1201 to electrically connect between end part of circuit board 1100 and end part of circuit board 1101 forming slit 110.

### Embodiment 7

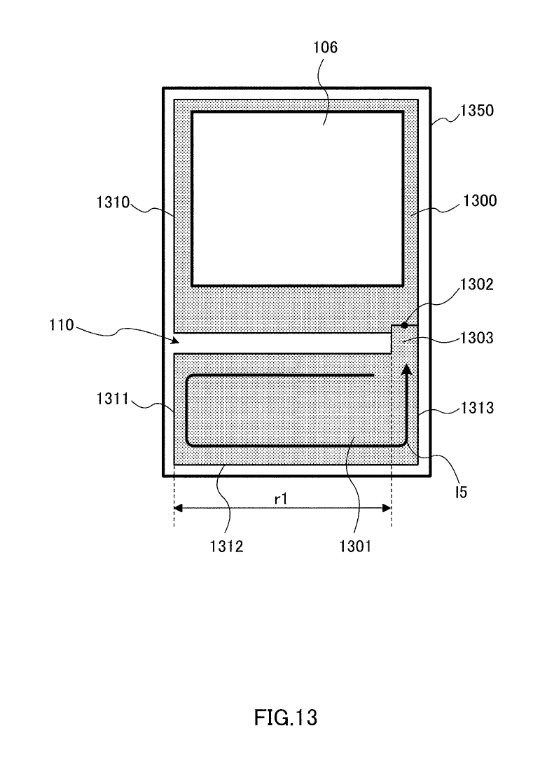

FIG. 13 is a plan view of first casing 1350 according to embodiment 7 of the present invention.

Compared to first casing 101 according to embodiment 1 shown in FIG. 3, first casing 1350 shown in FIG. 13 adds metal section 1301 and has circuit board 1300 instead of circuit board 105. Also, parts in FIG. 13 that are the same as in FIG. 3 will be assigned the same reference numerals as in FIG. 3 and overlapping descriptions will be omitted. The portable radio device except first casing 1350 according to the present embodiment is the same as the above embodiment 1 and the descriptions will be omitted.

First casing 1350 is formed in a rectangular shape in a plan view and is slidably attached to second casing 102 to switch from an open state to a closed state or to switch from a closed state to an open state, by sliding with first slide mechanism section 103. Thus, first casing 1350 is attached to second casing 102 to be able to slide along the lengthwise direction of first casing 1350. In an open state, by sliding with first slide member 103 that is bent to erect, first casing 1350 is held on second casing 102 in an erect state. First casing 1350 has circuit board 1300, metal section 1301, and display section 106.

Circuit board 1300 is provided in the upper part of first casing 1350 and display section 106 such as LCD is attached. Also, circuit board 1300 is electrically connected with metal section 1301.

Metal section 1301 is flat and is provided in the lower part of first casing 1350. In metal section 1301, projecting strip section 1303 is formed to be electrically connected with circuit board 1300 at connecting part 1302, and therefore is electrically connected with circuit board 1300. Metal section 1301 functions as the ground part of antenna 107.

Circuit board 1300 and metal sections 1301 form slit 110. The length of width r1 (see FIG. 13) from end part 1310 of circuit board 1300 of slit 110 makes, for example, the perimeter of metal section 1301 as half-wavelength (λ/2) of the frequency used by the portable radio device. The higher the frequency used by the portable radio device, the smaller the perimeter in metal section 1301 is placed. Here, the perimeter of metal section 1301 is referred to the length (15 in FIG. 13) along slit 110 and end parts 1311, 1312, and 1313 of metal section 1301.

In an open state, the portable radio device having the above configuration, electrically connects metal section 1301 and circuit board 108 through first slide mechanism section 103 and second slide mechanism section 104. However, the present embodiment provides slit 110 to electrically disconnect metal section 1301 below slit 110, and therefore suppresses the current transmitting in metal section 1301. By this means, in the present embodiment, it is possible to prevent degradation of antenna performance of antenna 107.

Therefore, the present embodiment provides, in a circuit board provided in the first casing, a slit that is located lower than a power feeding section in an open state, so that it is possible to electrically disconnect the part of the circuit board below the slit, and to prevent antenna performance degradation when a slide mechanism using a metal member is provided. The present embodiment provides an operation key section having a simple configuration below the slit provided in the circuit board, so that it is possible to provide the circuit patterns in a narrow area that is created by providing the slit. With the circuit board provided in the first casing, the present embodiment suppresses the current transmitting in the area below the slit and also provides an operation key section in the area below the slit, so that it is possible to reduce the influence to the antenna current caused by a hand operating the operation key section.

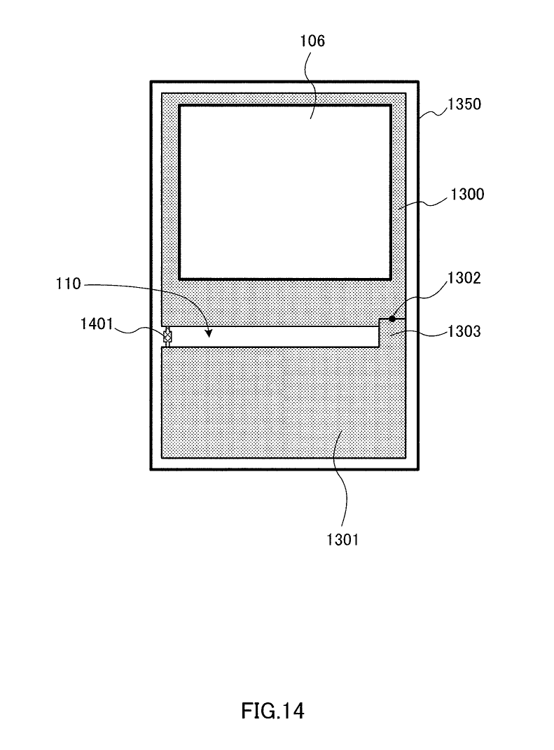

The present embodiment may provide a reactance element in slit 110. FIG. 14 is a plan view of the first casing showing another example of the first casing according to the present embodiment. From FIG. 14, the present embodiment may provide reactance element 1401 to electrically connect between end part of circuit board 1300 and end part of metal section 1301 forming slit 110.

### Embodiment 8

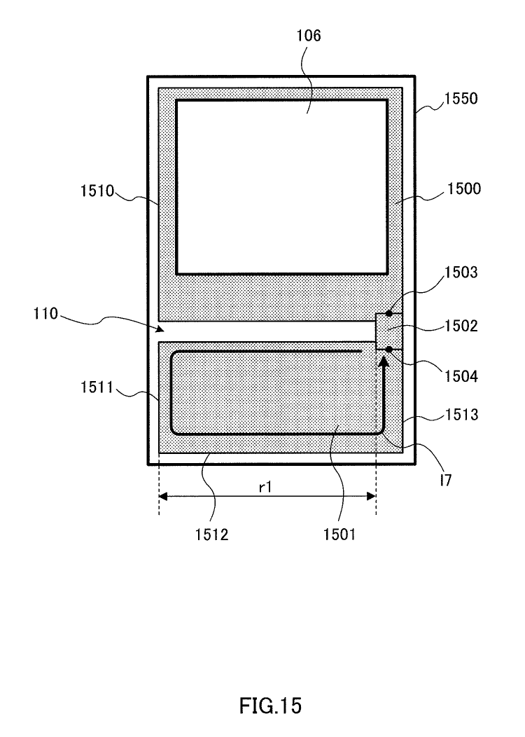

FIG. 15 is a plan view of first casing 1550 according to embodiment 8 of the present invention.

Compared to first casing 101 according to embodiment 1 shown in FIG. 3, first casing 1550 shown in FIG. 15 adds metal section 1501 and metal section 1502 and has circuit board 1500 instead of circuit board 105. Also, parts in FIG. 15 that are the same as in FIG. 3 will be assigned the same reference numerals as in FIG. 3 and overlapping descriptions will be omitted. The portable radio device except first casing 1550 according to the present embodiment is the same as the above embodiment 1 and the descriptions will be omitted.

First casing 1550 is formed in a rectangular shape in a plan view and is slidably attached to second casing 102 to switch from an open state to a closed state or to switch from a closed state to an open state, by sliding with first slide mechanism section 103. Thus, first casing 1550 is attached to second casing 102 to be able to slide along the lengthwise direction of first casing 1550. In an open state, by sliding with first slide mechanism section 103 that is bent to erect, first casing 1550 is held on second casing 102 in an erect state. First casing 1550 has circuit board 1500, metal section 1501, metal section 1502, and display section 106.

Circuit board 1500 is provided in the upper part of first casing 1550 and display section 106 such as LCD is attached. Circuit board 1500 is electrically connected with circuit board 1502 at connecting part 1503.

Metal section 1501 is flat and is provided in the lower part of first casing 1550. At connecting part 1504, metal section 1501 is electrically connected with circuit board 1502. Metal section 1501 functions as the ground part of antenna 107.

Metal section 1502 is flat, electrically connects with circuit board 1500 at connecting part 1503, and also electrically connects with metal section 1501 at connecting part 1504. Thus, metal section 1502 electrically connects circuit board 1500 and metal section 1501.

Circuit board 1500, metal section 1501, and metal section 1502 form slit 110. The length of width r1 (see FIG. 15) from end part 1510 of circuit board 1500 of slit 110 makes, for example, the perimeter of metal section 1501 as half-wavelength (λ/2) of the frequency used by the portable radio device. The higher the frequency used by the portable radio device, the smaller the perimeter of metal section 1501 is placed. Here, the perimeter of metal section 1501 is referred to the length (17 in FIG. 15) along slit 110 and end parts 1511, 1512, and 1513 of metal section 1501.

In an open state, the portable radio device having the above configuration, electrically connects metal section 1501 and circuit board 108 through first slide mechanism section 103 and second slide mechanism section 104. However, the present embodiment provides slit 110 to electrically disconnect metal section 1501 below slit 110, and therefore suppresses the current transmitting in metal section 1501. By this means, the present embodiment prevents antenna performance degradation of antenna 107.

Therefore, the present embodiment provides, in a circuit board provided in the first casing, a slit that is located lower than a power feeding section in an open state, so that it is possible to electrically disconnect the part of the circuit board below the slit, and to prevent antenna performance degradation when a slide mechanism using a metal member is provided. The present embodiment provides an operation key section having a simple configuration below the slit provided in the circuit board, so that it is possible to provide the circuit patterns in a narrow area that is created by providing the slit. With the circuit board provided in the first casing, the present embodiment suppresses the current transmitting in the area below the slit and also provides an operation key section in the area below the slit, so that it is possible to reduce the influence to the antenna current caused by a hand operating the operation key section.

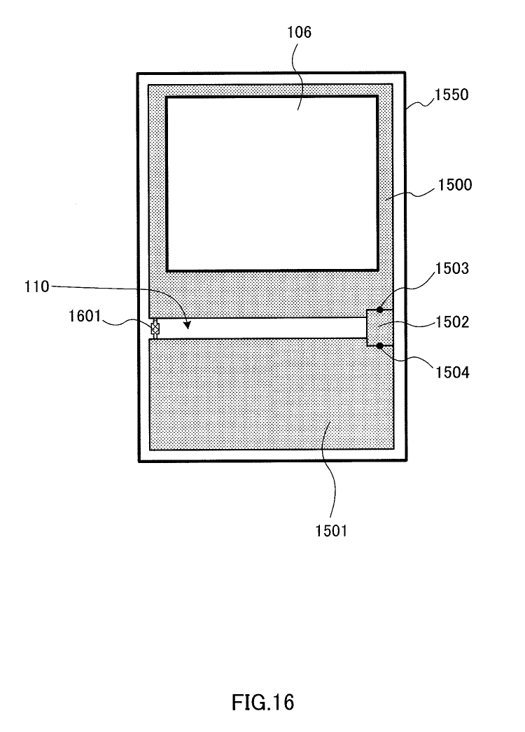

The present embodiment may provide a reactance element in slit 110. FIG. 16 is a plan view of the first casing showing another example of the first casing according to the present embodiment. From FIG. 16, the present embodiment may provide reactance element 1601 to electrically connect between end part of circuit board 1500 and end part of metal section 1501 forming slit 110.

### Embodiment 9

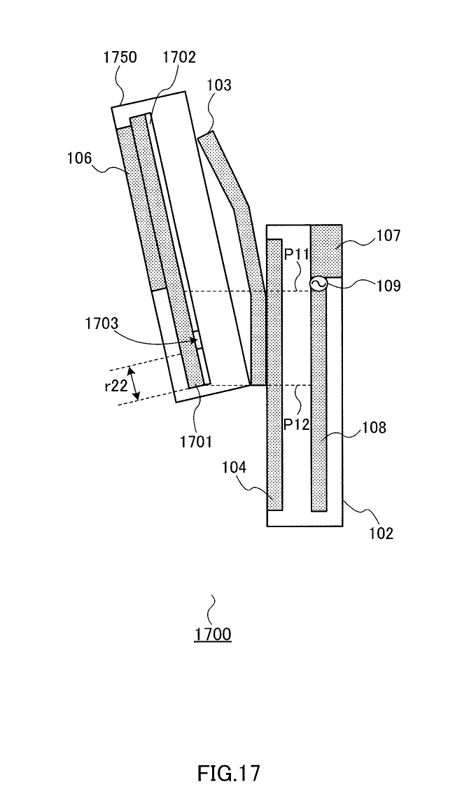

FIG. 17 is a side view of portable radio device 1700 according to the embodiment 9 of the present invention in an open state.

Compared to portable radio device 100 according to embodiment 1 shown in FIG. 1, portable radio device 1700 shown in FIG. 17 has first casing 1750 instead of first casing 101. Compared to first casing 101 of portable radio device 100 according to embodiment 1 shown in FIG. 1, first casing 1750 of portable radio device 1700 shown in FIG. 17 adds metal section 1702 and has circuit board 1701 instead of circuit board 105. Also, parts in FIG. 17 that are the same as in FIG. 1 will be assigned the same reference numerals as in FIG. 1 and overlapping descriptions will be omitted.

Portable radio device 1700 is mainly formed by second casing 102, first slide mechanism section 103, second slide mechanism section 104, display section 106, antenna 107, circuit board 108, power feeding section 109, circuit board 1701, metal section 1702 and first casing 1750.

First casing 1750 is formed in a rectangular shape in a plan view and is slidably attached to second casing 102 to switch from the open state of FIG. 17 to a closed state or to switch from a closed state to the open state of FIG. 17, by sliding with first slide mechanism section 103. Thus, first casing 1750 is attached to second casing 102 to be able to slide along the lengthwise direction (a vertical direction in FIG. 17) of first casing 1750. In the open state of FIG. 17, by sliding with first slide mechanism section 103 that is bent to erect, first casing 1750 is held on second casing 102 in an erect state. First casing 1750 has display section 106, circuit board 1701, and metal section 1702.

Second casing 102 is formed in a rectangular shape in a plan view and is slidably attached to first casing 1750 to switch from the open state of FIG. 17 to a closed state or to switch from a closed state to the open state of FIG. 17, by sliding with second slide mechanism section 104. Also, second casing 102 has second slide mechanism section 104 and circuit board 108. Second casing 102 has antenna 107 on the upper end part (the upper end part of FIG. 17). In an open state, second casing 102 holds first casing 1750 in an erect state as shown in FIG. 17, and overlaps with first casing 1750 in a closed state.

First slide mechanism section 103 is formed by bending a metal plate. Also, first slide mechanism section 103 slides in a vertical direction in FIG. 17, guided by a rail (not shown) provided in second slide mechanism section 104. First slide mechanism section 103 is attached to first casing 1750 and slides with first casing 1750. By sliding along a bent and erect shape guided by second slide mechanism section 104, in an open state, first slide mechanism section 103 holds first casing 1750 in an erect state with respect to second casing 102.

Circuit board 1701 is provided in first casing 1750 and display section 106 such as LCD is attached.

Display section 106 is, for example, a liquid crystal display apparatus (LCD) and is attached to circuit board 1701. Display section 106 shows, for example, image data that portable radio device 1700 receives.

Circuit board 108 is provided in second casing 102, and antenna 107 and power feeding section 109 are provided in its upper end part. In the open state of FIG. 17, on a plan view, the upper side of circuit board 108 overlaps with the lower side of circuit board 1701 and metal section 1702 (part between broken line P11 and broken line P12 in FIG. 17).

Metal section 1702 is flat, and is provided in a back face side of circuit board 1701 of first casing 1750. Metal section 1702 has slit 1703 extending from one end in a perpendicular direction to a slide direction of first casing 1750 and penetrates metal section 1702 in a thickness direction (a horizontal direction in FIG. 17). When first casing 1750 and second casing 102 are placed in an open state, slit 1703 is located lower (lower than broken line P11 in FIG. 17) than antenna 107 and power feeding section 109. Metal section 1702 functions as the ground part of antenna 107. Now, the details of slit 1703 will be described later.

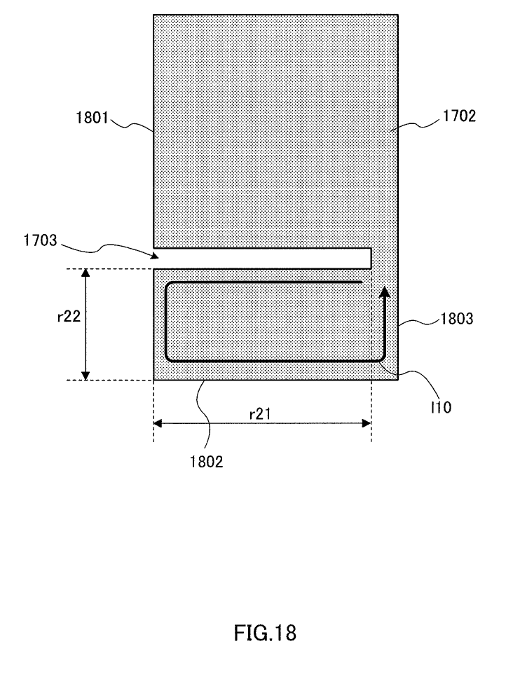

Next, a detailed configuration of metal section 1702 will be described using FIG. 18. FIG. 18 is a plan view of metal section 1702.

In metal section 1702, slit 1703 is formed from one end part 1801 of metal section 1702 in a perpendicular direction to a slide direction (a vertical direction in FIG. 18) of first casing 1750.

Slit 1703 is a through hole that is formed in metal section 1702 and that penetrates metal section 1702 in a thickness direction (a perpendicular direction to the sheet of FIG. 18). The length of width r21 (see FIG. 18) from end part 1801 of slit 1703 makes, for example, the perimeter of the lower side of slit 1703 in metal section 1702 as half-wavelength (λ/2) of the frequency used by portable radio device 1700. The higher the frequency used by portable radio device 1700, the smaller the perimeter below slit 1703 in metal section 1702 is placed. Here, in area r22 below slit 1703 in metal section 1702, the perimeter below slit 1703 in metal section 1702 is referred to the length (110 in FIG. 18) along slit 1703 and end parts 1801, 1802, and 1803 of metal section 1702.

Next, the reason antenna performance of antenna 107 is not degraded in portable radio device 1700 having the above configuration will be explained.

In the open state of FIG. 17, metal section 1702 and circuit board 108 are electrically connected at the part (part between P11 and P12) where metal section 1702 and circuit board 108 overlap one above the other, through first slide mechanism section 103 and second slide mechanism section 104. However, the present embodiment provides slit 1703 to electrically disconnect area r22 below slit 1703 in metal section 1702, and therefore suppresses the current transmitting in area r22 below slit 1703 in metal section 1702. Thus, the current transmitting in a direction to cancel the antenna current transmitting upward in FIG. 17 on circuit board 108 towards power feeding section 109, is suppressed. By this means, the present embodiment can prevent antenna performance degradation of antenna 107.

Therefore, the present embodiment provides, in a circuit board provided in the first casing, a slit that is located lower than a power feeding section in an open state, so that it is possible to electrically disconnect the part of the circuit board below the slit, and to prevent antenna performance degradation when a slide mechanism using a metal member is provided. The present embodiment provides an operation key section having a simple configuration below the slit provided in the circuit board, so that it is possible to provide the circuit patterns in a narrow area that is created by providing the slit. With the circuit board provided in the first casing, the present embodiment suppresses the current transmitting in the area below the slit and also provides an operation key section in the area below the slit, so that it is possible to reduce the influence to the antenna current caused by a hand operating the operation key section.

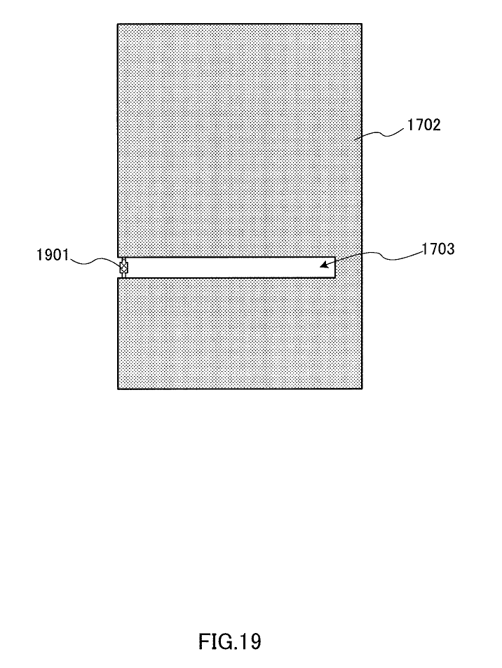

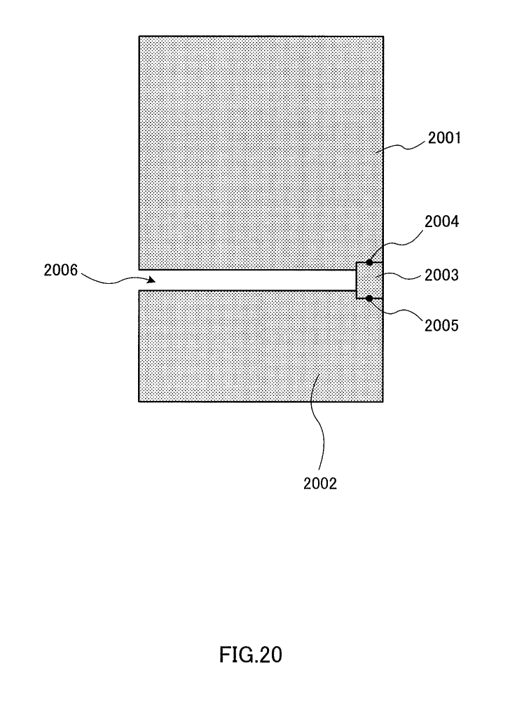

The present embodiment may provide a reactance element in slit 110. FIG. 19 is a plan view of a metal section showing another example of the metal section of the present embodiment. From FIG. 19, the present embodiment may provide reactance element 1901 to electrically connect between end parts forming slit 1703 of metal section 1702. Although the present embodiment forms slit 1703 in one metal section 1702, the present invention is not limited to this, and it is equally possible to connect multiple metal sections to form the slit. FIG. 20 is a plan view of a metal section showing yet another example of a metal section of the present embodiment. From FIG. 20, metal sections 2001, 2002, and 2003 may form slit 2006. Thus, metal section 2001 is flat, electrically connects with metal section 2003 in connecting part 2004, and metal section 2002 electrically connects with metal section 2003 in connecting part 2005.

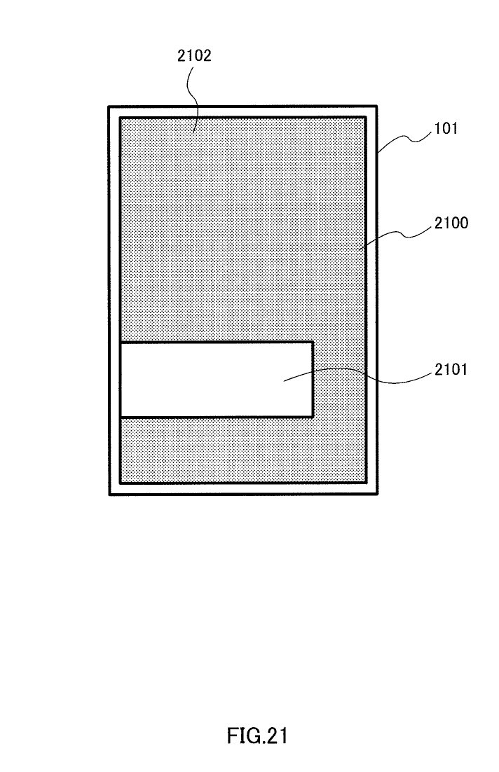

The above embodiments 1-5 can achieve the effect of the present invention without forming the slit on the circuit board, as described in each embodiment. FIG. 21 is a plan view of first casing 101 showing another example of the circuit board according to the above embodiments 1-4. Thus, from FIG. 21, circuit board 2100 may provide insulation section 2101, where metal pattern 2102 is not formed, instead of slit 110. This configuration can electrically disconnect the lower part of insulation section 2101 in circuit board 2100, so that it is possible to prevent antenna performance degradation. The same applies to the above embodiment 5, so that the description will be omitted.

Although the above embodiments 1-9 are designed to switch from a closed state to an open state when the first casing slides to erect from a second casing, the present invention is not limited to this, and the first casing may slide parallel to a second casing from a closed state to be an open state, and the slide structure may adopt an arbitrary method.

Although the above embodiments 1-9 form a slit that extends in a perpendicular direction to the slide direction of the first casing, the present invention is not limited to this, and it is equally possible to form a slit to extend in any arbitrary direction as long as it crosses the slide direction of the first casing.

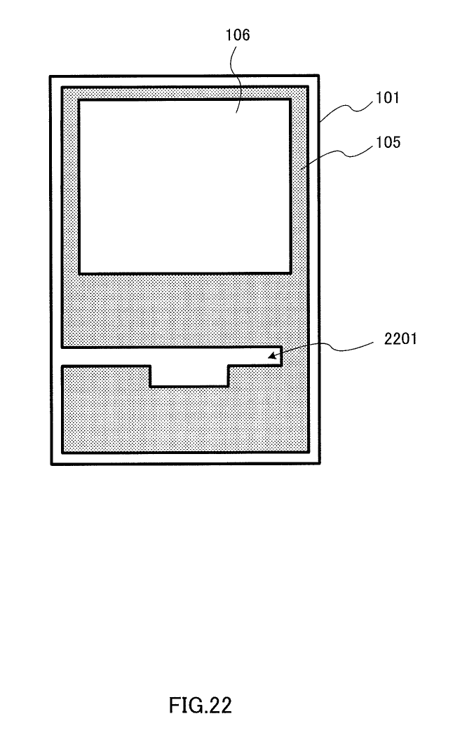

In the above embodiments 1-9, the shape of the slit does not necessarily have to be a linear shape but can be an arbitrary shape according to the frequency used by the portable radio device. FIG. 22 is a plan view of the first casing 101 showing another example of the slit provided in circuit board 105 according to embodiments 1-4. As FIG. 22 shows, by providing a concave and convex in the bottom part of slit 2201, it is possible to change the perimeter below the slit in a circuit board according to the used frequency. Also, it is equally possible to adjust the perimeter below the slit in a circuit board, by adjusting the depth length of the slit (the length of r1 in FIG. 3) or by adjusting the depth length of the slit and the concave-convex shape provided in the bottom part of the slit. Generally, the lower the used frequency is, the longer the perimeter below the slit in a circuit board is. The same applies to the above embodiments 5-9, so that the descriptions will be omitted.

Although the above embodiments 1-6 provide an operation key section in the lower side than the slit of a circuit board, the present invention is not limited to this, and it is equally possible to provide any arbitrary member other than an operation key section may be arranged.

The disclosure of Japanese Patent Application No. 2009-3635, filed on Jan. 9, 2009, including the specification, drawings and abstract, is incorporated herein by reference in its entirety.

### INDUSTRIAL APPLICABILITY

A portable radio device of the present invention is especially suitable to connect a plurality of casings in a mutually slidable fashion and is placed in an open state and a closed state in accordance with slide operations.

1. A portable radio device comprising:
a first casing;
a second casing that is slidably attached to the first casing;
a first circuit board that is provided in the first casing;
a second circuit board that is provided in the second casing and that overlaps with a lower side of the first circuit board in a plan view when the first casing slides into an open state;
an antenna that is provided in an upper side of the second casing; and
a power feeding section that is provided near the antenna and that feeds power to the antenna, wherein the first circuit board comprises an insulation section that extends in a direction to cross a slide direction of the first casing and that is located lower than the power feeding section in the open state.

2. The portable radio device according to claim 1, wherein the insulation section is a slit to penetrate the first circuit board in a thickness direction.

3. The portable radio device according to claim 2, further comprising a reactance element that electrically connects between end parts forming the slit of the first circuit board and opposing each other.

4. The portable radio device according to claim 1, wherein a ground part of the second circuit board is electrically connected to a ground part of the first circuit board above the insulation section through a cable.

5. The portable radio device according to claim 1, wherein the power feeding section feeds power to an upper part than the insulation section in the ground part of the first circuit board.

6. The portable radio device according to claim 1, wherein the first circuit board comprises an operation key section in a lower part than the insulation section.

7. The portable radio device according to claim 1, wherein the first circuit board comprises a plurality of insulation sections.

8. A portable radio device comprising:
a first casing;
a second casing that is slidably attached to the first casing;
a metal section that is flat and that is provide in the first casing;
a circuit board that is provided in the second casing and that overlaps with a lower side of the metal section in a plan view when the first casing slides into an open state;
an antenna that is provided in an upper side of the second casing; and
a power feeding section that is provided near the antenna and that feeds power to the antenna, wherein the metal section comprises an insulation section that extends in a direction to cross a slide direction of the first casing and that is located lower than the power feeding section in the open state.

9. The portable radio device according to claim 8, wherein the insulation section is a slit to penetrate the metal section in a thickness direction.

10. The portable radio device according to claim 9, further comprising a reactance element that electrically connects between end parts forming the slit of the metal section.

11. A portable radio device comprising:
a first casing;
a second casing that is slidably attached to the first casing;
a first circuit board that is provided in the first casing;
a second circuit board that is provided in the first casing;
a signal wire that connects the first circuit board and the second circuit board;
a third circuit board that is provided in the second casing and that overlaps with the second circuit board in a plan view when the first casing slides into an open state;
an antenna that is provided in an upper side of the second casing; and
a power feeding section that is provided near the antenna and that feeds power to the antenna, wherein:
the first circuit board, the second circuit board, and the signal wire form a slit; and
the slit has a lengthwise direction that crosses a slide direction of the first casing, and is located lower than the power feeding section in the open state.

12. The portable radio device according to claim 11, further comprising a reactance element that electrically connects between an end part of the first circuit board and an end part of the second circuit board that form the slit.
